(19) United States
(12) Patent Application Publication
(10) Pub. No.: US 2012/0327043 A1
(43) Pub. Date: Dec. 27, 2012

(54) STYLUS CAPABLE OF BEING APPLIED IN VARIOUS TOUCH PANELS

(75) Inventor: Kuei-Huang Wu, Dasi Township (TW)

(73) Assignees: Chia-Yu Chang, New Taipei City (TW); TOP-BOUND ENTERPRISE CO. LTD., New Taipei City (TW)

(21) Appl. No.: 13/169,017

(22) Filed: Jun. 27, 2011

(51) Int. Cl. G06F 3/033

(52) U.S. Cl. 345/179

(57) ABSTRACT

The present invention relates to a stylus capable of being applied in various touch panels, wherein the stylus consists of a conductive pen tube, a conductive rubber pen lead and a conductive rod. The conductive rubber pen lead is made by a conductive rubber and is sprayed with a conductive wearing material, moreover, the conductive rubber pen lead has an accommodating space disposed in the interior thereof, so that, when the conductive rubber pen lead touches and slightly presses a panel, the contact area between the conductive rubber pen lead and the panel would be increased due to the accommodating space; In addition, the conductive pen tube of the stylus has at least one electrical discharge device, which include a PCB and a battery, connecting with the conductive rod and the conductive pen tube through conductive wire, respectively, so that a circuit loop is formed in the conductive pen tube; therefore, by way of the circuit loop, the sensitivity of the stylus can be greatly increased.

### BACKGROUND OF THE INVENTION

1. Technical Field

The present invention relates to stylus, and more particularly, to a stylus which is capable of being applied in various touch panels, such as contacted type, surface capacitive, projected capacitive, infrared type, and surface acoustic wave touch panel.

2. Description of Related Art

Recently, the technology of touch panel has been developed various types, having contacted type, surface capacitive type, projected capacitive type, infrared type, surface acoustic wave, etc. However, there's no stylus has been applied in all kind of the touch panel.

The FIG. 1A shows a stereo view of a first conventional stylus, which is capable of being applied in capacitive touch panel, wherein the first conventional stylus consists of a body 10a, a lock ring 11a, and a first conductive head 12a. wherein said first conductive head 12a fixes with said body 10a by said lock ring 11a, and a space being deposed inside first conductive head 12a. The appearance of the first conductive head 12a can be arc-shaped, concave-shaped, or trapezoid-shape. However, a contact area between first conductive head 12a and the touch panel might be insufficient, and cause poor sensibility. To avoid this issue, the size of first conductive head 12a needs to be large, to increase the contact area.
1. To keep the size of first conductive head 12a as small, and contact area is still sufficient, foam has been generally used in the material of first conductive head 12a. However, foam is easy out of shape and damage. When first conductive head 12a slides on the surface of touch panel, the damage might cause scratch on touch panel.
2. The FIG. 1B shows a sectional view of a second conventional stylus, which is capable of being applied in touch panel, wherein the second conventional stylus consists of a metal body 20a, a second conductive head 21a, a pen cover 22a, a copper bar 23a. wherein said copper bar 23a is a coil and wound around by copper line 24a, said second conductive head 21a is covered by a conductive material 25a such like, for example conductive foam or metal fabric. After being used for a period of time, the conductive material 25a would suffer elastic fatigued and loose, then cause issue such like, for example, structure damage, metal powder drop, and poor sensibility.

### BRIEF SUMMARY OF THE INVENTION

The primary objective of the present invention is to provide a stylus capable of being applied in various touch panels, wherein the stylus consists of a conductive pen tube, a conductive rubber pen lead and a conductive rod; The conductive rubber pen lead is sprayed with a conductive wearing material, and the conductive rod is inserted to the conductive rubber pen lead for expensing the diameter of the upside of the pen lead, such that the conductive rod can be fixed and positioned when the conductive rubber pen lead is combined with the conductive pen tube; Moreover, the conductive rubber pen lead has an accommodating space disposed in the interior thereof, so that, when the conductive rubber pen lead touches and slightly presses a panel, the contacted area between the conductive rubber pen lead and the panel would be increased due to the accommodating space; Besides, since the conductive rubber pen lead is sprayed with the conductive wearing material, the roughness of the pen lead is improved, and then, the stylus can be smoothly moved on the panel when writing the panel.

The another objective of the present invention is to provide a stylus capable of being applied in various touch panels, in which, a conductive pen tube of the stylus has at least one electrical discharge device, which include a PCB and a battery, and electrically connecting with the conductive rod and the conductive pen tube through conductive wire, respectively, so that a circuit loop is formed in the conductive pen tube; therefore, by way of the circuit loop, the sensitivity of the stylus can be greatly increased.

Accordingly, to achieve the abovementioned objectives of the present invention, the inventor proposes a stylus capable of being applied in various touch panels, comprising: a conductive pen tube; a conductive rubber pen lead, having an accommodating space and a conductive wearing material disposed in the inside and sprayed on the outside of the conductive rubber pen lead, respectively; and a conductive rod, disposed in the accommodating space.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1A is a stereo view of a first conventional stylus;

FIG. 1B is a sectional view of a second conventional stylus;

FIG. 2 is a sectional view of a first embodiment of a stylus capable of being applied in various touch panels according to the present invention;

FIG. 3 is a sectional view of a second embodiment of the stylus capable of being applied in various touch panels according to the present invention;

FIG. 4A is a sectional view of a third embodiment of the stylus capable of being applied in various touch panels according to the present invention which is extended;

FIG. 4B is a sectional view of a third embodiment of the stylus capable of being applied in various touch panels according to the present invention which is retracted;

FIG. 5A is a schematic view of a first type appearance shape for a conductive rubber pen lead of the stylus capable of being applied in various touch panels according to the present invention;

FIG. 5B is a schematic view of a second type appearance shape for the conductive rubber pen lead of the stylus capable of being applied in various touch panels according to the present invention;

FIG. 5C is a schematic view of a third type appearance shape for the conductive rubber pen lead of the stylus capable of being applied in various touch panels according to the present invention; and

FIG. 5D is a schematic view of a fourth type appearance shape for the conductive rubber pen lead of the stylus capable of being applied in various touch panels according to the present invention.

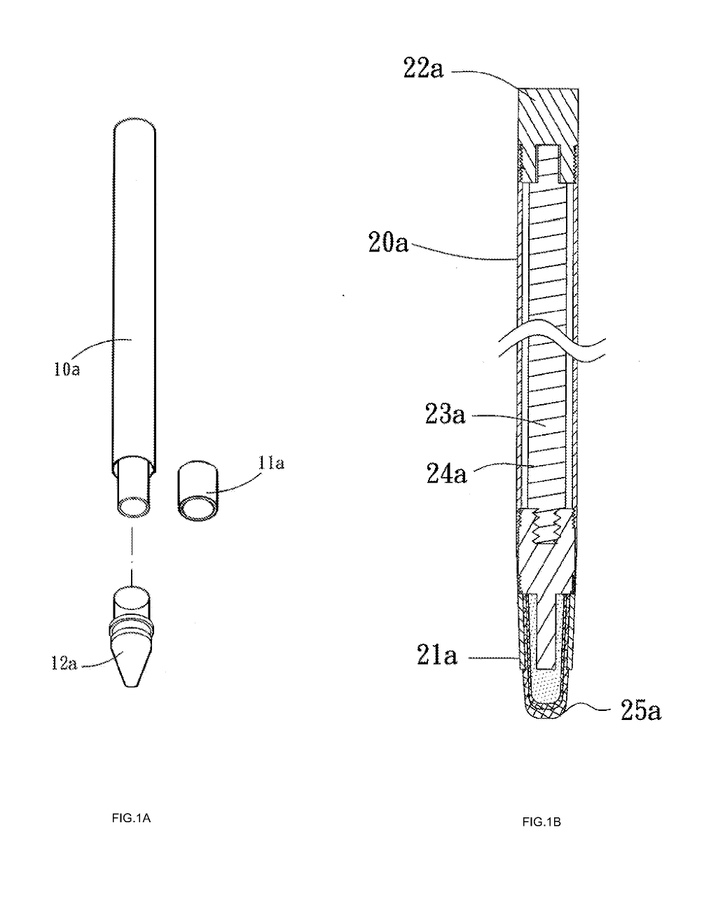

### DETAILED DESCRIPTION OF THE INVENTION

To more clearly describe a stylus capable of being applied in various touch panels according to the present invention, an embodiment of the present invention will be described in detail with reference to the attached drawings hereinafter.

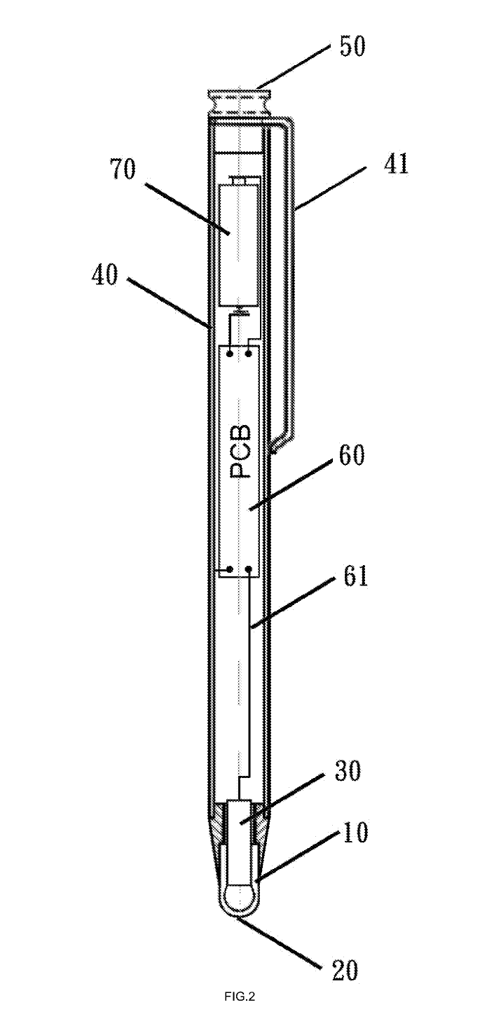

Referring to FIG. 2, which illustrates a sectional view of a first embodiment of a stylus capable of being applied in various touch panels according to the present invention. As shown in FIG. 2, the stylus capable of being applied in various touch panels includes: a conductive pen tube 40, a conductive rubber pen lead 10 and a conductive rod 30, wherein the conductive rubber pen lead 10 is connected to one end of the conductive pen tube 40 and has an accommodating space and a conductive wearing material disposed in the inside and sprayed on the outside of the conductive rubber pen lead 10, respectively. The shape of the accommodating space disposed in the conductive rubber pen lead is egg-shaped. When the stylus touch a panel, the conductive rubber pen lead 10 touches and slightly presses the panel, the contact area between the conductive rubber pen lead 10 and the panel would be increased due to the deformation of the accommodating space; Besides, since the conductive rubber pen lead 10 is sprayed with the conductive wearing material, the roughness of the pen lead is improved, and then, the stylus can be smoothly moved on the panel when writing the panel.

Moreover, the conductive rod 30, which is disposed in the accommodating space and expenses the diameter of the upside of the pen lead 10, such that the conductive rod 30 can be fixed and positioned when the conductive rubber pen lead 10 is combined with the conductive pen tube 40. The conductive pen tube 40 of the stylus has at least one electrical discharge device, which include a PCB 60 and a battery 70, and electrically connecting with the conductive rod 30 and the conductive pen tube 40 through conductive wire 61, respectively, so that a circuit loop is formed in the conductive pen tube 40. If the panel is conventional contacted type, the panel would respond when the surface of the panel is slightly pressed by the stylus; if the panel is surface capacitive type, the capacitance on the surface of the panel would be reacted by way of the circuit loop when the stylus is slightly pressed the surface of the panel, the sensitivity of the stylus can be greatly increased.

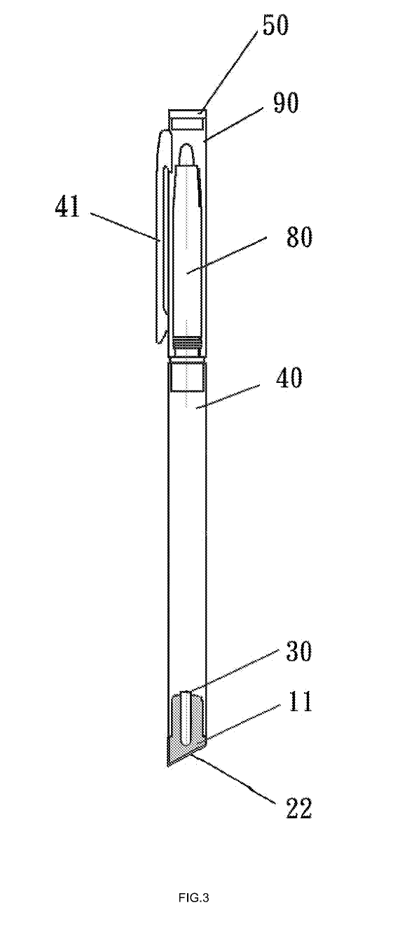

Referring to FIG. 3, which illustrates a sectional view of a second embodiment of a stylus capable of being applied in various touch panels according to the present invention. The appearance of the conductive rubber pen lead 10 can be changed if necessary, as shown in FIG. 3, the shape of the conductive rubber pen lead 10 is cylindrical, and the top surface of the conductive rubber pen lead 10 is a slanted surface. A ball-point pen 80 and a first cover 90 are connected with one end of the conductive pen tube 40 opposite to the conductive rubber pen lead 10, and the ball-point pen 80 is deposed inside the first cover 90. A pen top 50 of the first cover 90 is for isolating the ball-point pen 80 from the outer effect of the first cover 90. A pen clip 41 is deposed at a side of the first cover 90, wherein when it puts the stylus into a pocket, the pen clip 41 can be an effective penholder.

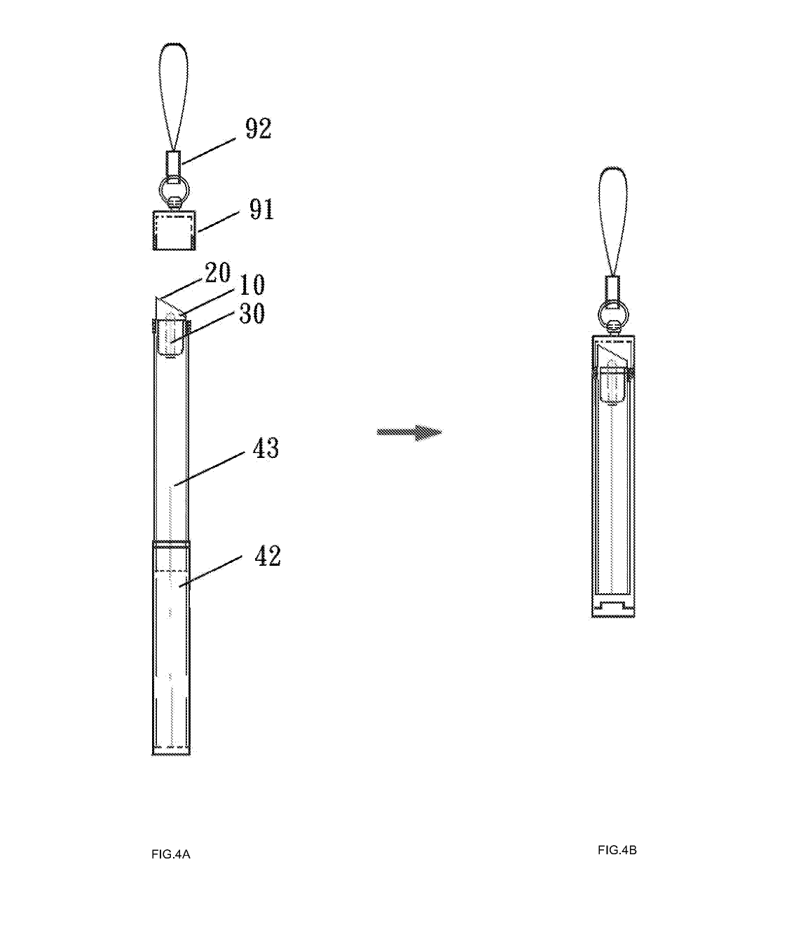

Referring to FIG. 4A and 4B, which illustrates a sectional view of a third embodiment of a stylus capable of being applied in various touch panels according to the present invention. A second cover 101 is connected with the end of the conductive pen tube 40 for protecting the conductive rubber pen lead 10 from being damage. In addition, a hanger 102 is connected with the second cover 101, used for conveniently hanging the stylus. In the third embodiment, the conductive pen tube 40 further includes an inner tube 43 and an outer tube 42, the inner tube 43 can be located inside of the outer tube 42, and the length of the conductive pen tube 40 can be adjusted thus.

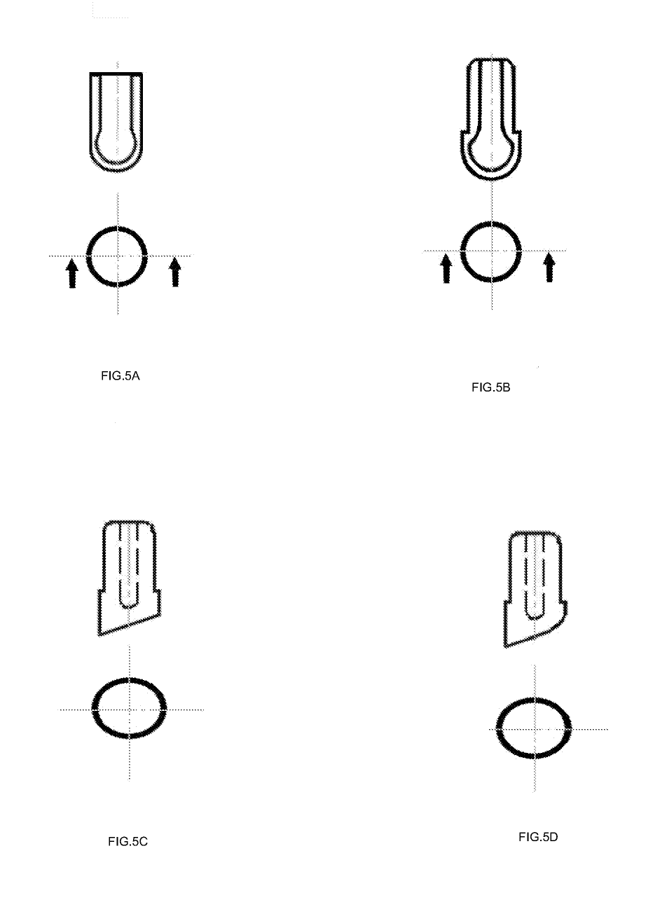

Referring to FIGS. 5A, 5B, 5C and 5D, there are shown a first type appearance shape, a second type appearance shape, a third type appearance shape and a fourth type appearance shape for the conductive rubber pen lead of the stylus capable of being applied in various touch panels according to the present invention. As shown in FIG. 5A and 5B, the appearance of the conductive rubber pen lead 10 is cylindrical shape, and the surface of the cylindrical-shaped conductive rubber pen lead 10 is an arc surface; As shown in FIG. 5C, the appearance of the conductive rubber pen lead 10 is cylindrical shape, and the top surface of the cylindrical-shaped conductive rubber pen lead 10 is a slanted surface; As shown in FIG. 5D, the appearance of the conductive rubber pen lead 10 is cylindrical, and the top surface of the cylindrical-shaped conductive rubber pen lead 10 includes one arc surface and one slanted surface, wherein the arc surface is connected with one slanted surface.

Thus, the stylus according to the present invention has been disclosed above completely and clearly. In summary, the present invention has the following advantages:
1. As the present invention has the accommodating space disposed inside the conductive rubber pen lead 10, the shape of the accommodating space is egg-shaped. When the stylus touch a panel, the conductive rubber pen lead 10 touches and slightly presses the panel, the contact area between the conductive rubber pen lead 10 and the panel would be increased due to the deformation of the accommodating space; Besides, since the conductive rubber pen lead 10 is sprayed with the conductive wearing material, the roughness of the pen lead is improved, and then, the stylus can be smoothly moved on the panel when writing the panel.
2. As the present invention has at least one electrical discharge device, which include a PCB 60 and a battery 70, and electrically connecting with the conductive rod 30 and the conductive pen tube 40 through conductive wire 61, respectively, so that a circuit loop is formed in the conductive pen tube 40. For the panel is surface capacitive type, the capacitance on the surface of the panel would be reacted by way of the circuit loop when the stylus is slightly pressed the surface of the panel, the sensitivity of the stylus can be greatly increased.

I claim:

1. A stylus capable of being applied in various touch panels, comprising:
a conductive pen tube;
a conductive rubber pen lead, being connected to one end of the conductive pen tube 40 and having an accommodating space and a conductive wearing material disposed in the inside and sprayed on the outside of the conductive rubber pen lead, respectively; and
a conductive rod, being disposed in the accommodating space.

2. The stylus capable of being applied in various touch panels of claim 1, wherein said conductive rod is disposed in the accommodating space, and expenses the diameter of the upside of the pen lead, such that the conductive rod can be fixed and positioned when the conductive rubber pen lead is combined with the conductive pen tube.

3. The stylus capable of being applied in various touch panels of claim 1, wherein the manufacturing material of the conductive pen tube is selected from the group consisting of:
plastic material with conductive material and conductive material.

4. The touch pan for multifarious of touch panel of claim 1, wherein the conductive rubber pen lead is made by a conductive rubber with hardness range in 15˜50 HS.

5. The stylus capable of being applied in various touch panels of claim 1, wherein the appearance of the conductive rubber pen lead is sphere-shaped, and the accommodating space disposed in the conductive rubber pen lead being egg-shaped.

6. The stylus capable of being applied in various touch panels of claim 4, wherein the appearance shape of the conductive rubber pen lead is selected from the group consisting of:
cylindrical shape with one arc surface, cylindrical shape with one slanted surface and cylindrical shape having one arc surface connected with one slanted surface.

7. The stylus capable of being applied in various touch panels of claim 1, wherein the conductive pen tube further comprises at least one electrical discharge device, which include a PCB(printed circuit board) and a battery, and electrically connecting with the conductive rod and the conductive pen tube through conductive wire, respectively.

8. The stylus capable of being applied in various touch panels of claim 1, wherein the conductive pen tube is capable of connecting with an object selected from the group consisting of: ball-point pen and mini-tool.

9. The stylus capable of being applied in various touch panels of claim 1, wherein the conductive pen tube is capable of being refracted and extended, further dividing into an outer tube and an inner tube.
